(19) United States
(12) Patent Application Publication
(10) Pub. No.: US 2025/0238560 A1
(43) Pub. Date: Jul. 24, 2025

(54) INFORMATION PROCESSING DEVICE

(71) Applicant: NIDEC INSTRUMENTS CORPORATION, Nagano (JP)

(72) Inventor: Junro TAKEUCHI, Nagano (JP)

(21) Appl. No.: 19/023,317

(22) Filed: Jan. 16, 2025

(30) Foreign Application Priority Data
Jan. 19, 2024 (JP) 2024-006738

(51) Int. Cl. G06F 21/86; G06F 3/044

(52) U.S. Cl. CPC G06F 21/86; G06F 3/0447

(57) ABSTRACT

An information processing device includes a display with a touch panel to which secret information is inputted. The display includes a touch position detection mechanism which detects a touched position of the touch panel, and at least one of a flexible printed board formed with a detection circuit for detecting at least one of its own disconnection and short circuit and a signal circuit for transmitting an output signal of the touch position detection mechanism, and a disassembly detection mechanism for detecting that the display is disassembled. A control part which controls the display executes a predetermined tamper-resistant processing when the control part detects at least one of disconnection and a short circuit of the detection circuit or, the control part executes the tamper-resistant processing when the control part detects that the display is disassembled.

### CROSS REFERENCE TO RELATED APPLICATION

The present invention claims priority under 35 U.S.C. § 119 to Japanese Application No. 2024-006738 filed Jan. 19, 2024, the entire content of which is incorporated herein by reference.

### TECHNICAL FIELD

At least an embodiment of the present invention may relate to an information processing device.

### BACKGROUND ART

Conventionally, an information processing device (information input device) for inputting secret information such as a personal ID number (PIN (Personal Identification Number)) has been known (for example, see Japanese Patent Laid-Open No. 2022-184078 (Patent Literature 1)). An information processing device described in Patent Literature 1 includes a main control part, a display part and an instruction acquisition part. The display part is a display such as a liquid crystal display. The instruction acquisition part is a touch panel and is integrally formed with the display part.

In the information processing device described in Patent Literature 1, the instruction acquisition part acquires instruction information indicating an instruction of a user to the display part, and the instruction information is encrypted and transmitted to the main control part. Specifically, the instruction acquisition part detects positions (coordinates) of the display part where a user touches, and the positions (coordinates) are encrypted and transmitted to the main control part. Therefore, in the information processing device described in Patent Literature 1, secret information inputted in the instruction acquisition part can be prevented from being illegally acquired between the instruction acquisition part and the main control part.

The present inventor has been developing an information processing device including a display with a touch panel which is inputted with secret information requiring security of safety similarly to the information processing device described in Patent Literature 1. In the information processing device under development, in order to prevent illegal acquisition of secret information inputted from a touch panel, it is preferable that safety (security) of a display with a touch panel itself is enhanced.

### SUMMARY

In view of the problem described above, at least an embodiment of the present invention may advantageously provide an information processing device including a display with a touch panel to which secret information is inputted, safety of the display with a touch panel itself being enhanced.

According to at least an embodiment of the present invention, there may be provided an information processing device including a display with a touch panel to which secret information is inputted. The display includes a touch position detection mechanism which detects a touch position that is a touched position of the touch panel, a battery which supplies power to the display in a state that power is not supplied from the outside, and at least one of a flexible printed board which is formed with a detection circuit for detecting at least one of its own disconnection and short circuit, and a signal circuit for transmitting an output signal of the touch position detection mechanism, and a disassembly detection mechanism for detecting that the display is disassembled. In a case that the display includes the flexible printed board, a control part which controls the display executes a predetermined tamper-resistant processing when the control part detects at least one of disconnection and a short circuit of the detection circuit and, in a case that the display includes the disassembly detection mechanism, the control part executes the tamper-resistant processing when the control part detects that the display is disassembled.

In the information processing device in this embodiment, the display with a touch panel includes at least one of the flexible printed board formed with the detection circuit and the disassembly detection mechanism. Further, in this embodiment, in a case that the display includes the flexible printed board, the control part controlling the display executes a predetermined tamper-resistant processing when at least one of disconnection and a short circuit of the detection circuit is detected and, in a case that the display includes the disassembly detection mechanism, the control part executes the tamper-resistant processing when the control part detects that the display is dis assembled.

In other words, in this embodiment, when the control part detects an illegal act to the display with a touch panel, the tamper-resistant processing is executed. Therefore, according to this embodiment, safety of the display with a touch panel itself can be enhanced. Further, in this embodiment, safety of the display with a touch panel itself can be enhanced and thus, the information processing device which requires safety can be easily designed.

### Effects of the Invention

As described above, in accordance with an embodiment of the present invention, in an information processing device having a display with a touch panel to which secret information is inputted, safety of the display with a touch panel itself can be enhanced.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view showing an information processing device in accordance with an embodiment of the present invention.

FIG. 2 is a block diagram for explaining a configuration of the information processing device shown in FIG. 1.

FIG. 3 is a perspective view showing a protection board, a display and the like which are accommodated in a housing shown in FIG. 1.

FIG. 4 is a schematic view for explaining a structure of a display shown in FIG. 1.

FIG. 5 is a cross-sectional view showing a flexible printed board shown in FIG. 4.

### DETAILED DESCRIPTION

An embodiment of the present invention will be described below with reference to the following drawings.

### (Structure of Information Processing Device)

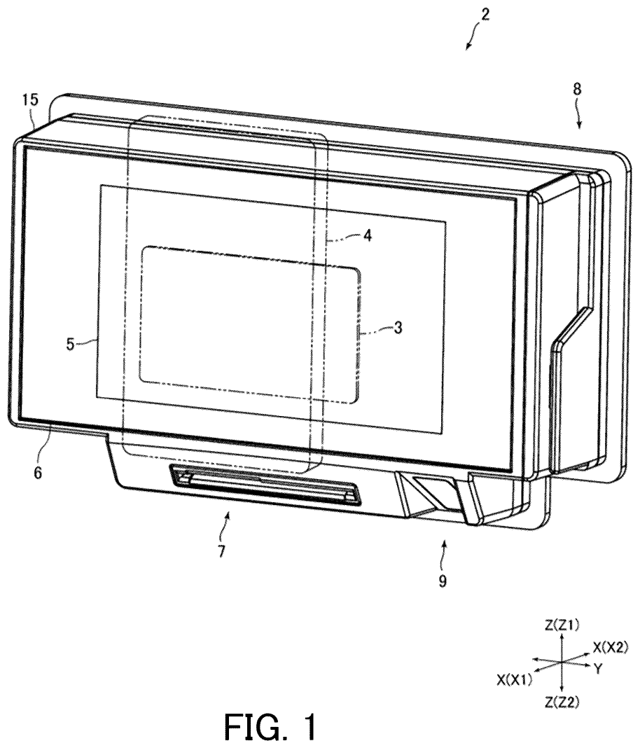

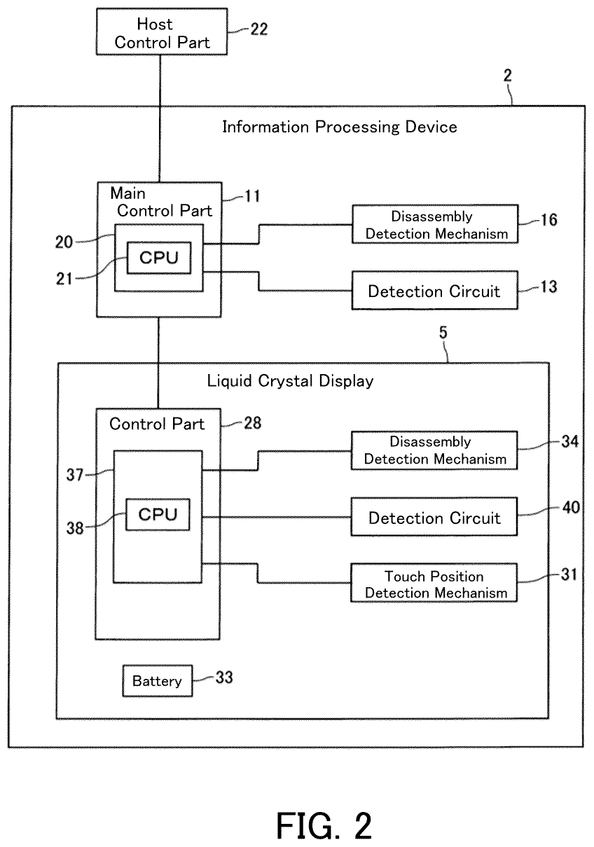

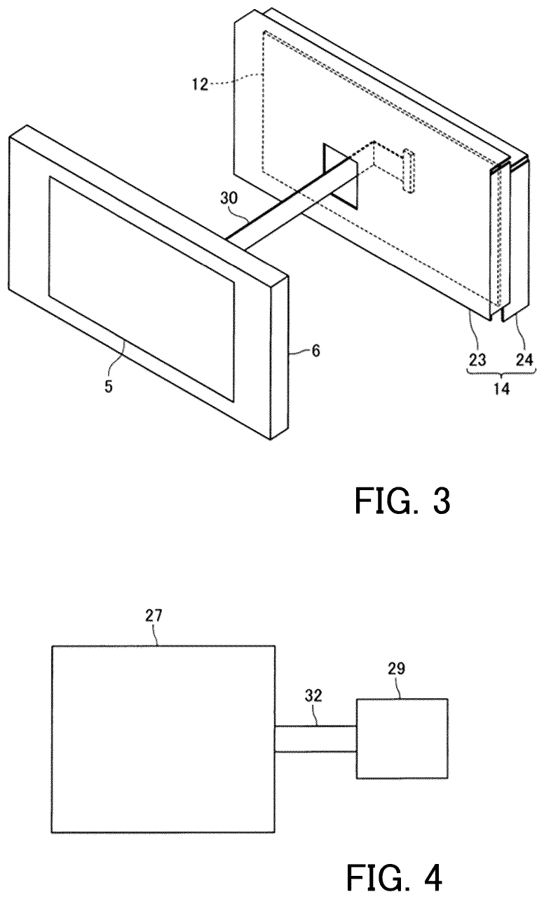

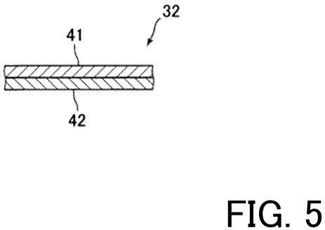

FIG. 1 is a perspective view showing an information processing device 2 in accordance with an embodiment of the present invention. FIG. 2 is a block diagram for explaining a configuration of the information processing device 2 shown in FIG. 1. FIG. 3 is a perspective view showing a protection board 14, a display 5 and the like which are accommodated in a housing 15 shown in FIG. 1. FIG. 4 is a schematic view for explaining a structure of a display 5 shown in FIG. 1. FIG. 5 is a cross-sectional view showing a flexible printed board 32 shown in FIG. 4.

In the following descriptions, for convenience of explanation, the “Z”-direction in FIG. 1 is defined as an upper and lower direction, the “X”-direction in FIG. 1 perpendicular to the upper and lower direction is defined as a front and rear direction, and the “Y”-direction in FIG. 1 perpendicular to the upper and lower direction and the front and rear direction is defined as a right and left direction. Further, the “Z1”-direction side in FIG. 1 which is one side in the upper and lower direction is referred to as an “upper” side, the “Z2”-direction side in FIG. 1 which is an opposite side to the upper side is referred to as a “lower” side, the “X1”-direction side in FIG. 1 which is one side in the front and rear direction is referred to as a “front” side, and the “X2”-direction side in FIG. 1 which is an opposite side to the front side is referred to as a “rear” side.

The information processing device 2 in this embodiment is a device for processing information including secret information. The information processing device 2 is, for example, a settlement terminal device used in settlement of a price. Further, the information processing device 2 is, for example, mounted and used in a host apparatus such as an automatic ticket issuing machine, a vending machine, an entry-exit management device or an ATM (Automatic Teller Machine). The information processing device 2 is formed in a flat and substantially rectangular parallelepiped shape as a whole whose thickness in the front and rear direction is thin. An outside shape of the information processing device 2 when viewed in the front and rear direction is a substantially rectangular shape whose long side direction is the right and left direction. In this embodiment, a user who employs the information processing device 2 performs various operations from a front side of the information processing device 2.

The information processing device 2 is provided with an information communication function which performs communication of information with a non-contact type IC card 3 (hereinafter, referred to as a “card 3”) or a smartphone 4 in a non-contact manual manner. Further, the information processing device 2 is also provided with a function as an input device to which secret information is inputted by using a finger-tip of a user. In the information processing device 2, for example, a personal ID number such as a personal identification number is inputted. In the information processing device 2, a card 3 which is a contact type IC card or a card 3 which is a magnetic card may be used. In other words, a card 3 which is used in the information processing device 2 may be formed with an external connection terminal of an IC chip and a magnetic stripe.

The information processing device 2 includes a display 5 with a touch panel to which secret information such as a personal ID number is inputted and a frame member 6 in a frame shape surrounding the display 5. The display 5 is fixed to the frame member 6. In this embodiment, the display 5 and the frame member 6 structure a front face portion of the information processing device 2. Further, the information processing device 2 includes a flexible printed board (not shown) on which a communication antenna is mounted for performing communication of information with a card 3 or a smartphone 4 in a non-contact manner. The flexible printed board is, for example, formed in a rectangular frame shape and is disposed on a rear side of the frame member 6. Further, the flexible printed board is accommodated in a housing 15 described below.

In addition, the information processing device 2 includes an IC card processing part 7 for performing communication of data with a contact type IC card, a magnetic card processing part 8 for performing reading of magnetic data recorded in a magnetic card and/or recording magnetic data to the magnetic card, and a code reading part 9 for reading a two-dimensional code displayed on the smartphone 4.

Further, the information processing device 2 includes a control board 12 on which a main control part 11 controlling the information processing device 2 is mounted, a protection board 14 which is formed with a detection circuit 13 for detecting its own disconnection and its short circuit, a housing 15 in which the control board 12 and the protection board 14 are accommodated, and a disassembly detection mechanism 16 for detecting that the information processing device 2 is disassembled. The detection circuit 13 in this embodiment is a second detection circuit, and the disassembly detection mechanism 16 is a second disassembly detection mechanism.

The IC card processing part 7 is a manually operated dip type card reader. The IC card processing part 7 includes an IC contact block having a plurality of IC contact springs which are capable of contacting with external connection terminals of a contact type IC card. The magnetic card processing part 8 is a manually operated swipe type card reader. The magnetic card processing part 8 includes a magnetic head which performs reading and/or recording of magnetic data. The code reading part 9 includes a camera for reading a two-dimensional code. The IC card processing part 7 and the code reading part 9 are disposed on a front face side and a lower face side of the information processing device 2. The magnetic card processing part 8 is disposed at an end part in the right and left direction of the information processing device 2.

The control board 12 is a rigid board such as a glass epoxy substrate. The control board 12 is formed in a flat plate shape. The main control part 11 includes a microcomputer 20. The microcomputer 20 includes a CPU (Central Processing Unit) 21. Further, the microcomputer 20 includes a ROM (Read Only Memory), a RAM (Random Access Memory), peripheral circuits and the like. The main control part 11 is electrically connected with a host control part (host) 22.

The main control part 11 is electrically connected with the communication antenna for communicating with a card 3 or the like, the IC contact springs of the IC card processing part 7, the magnetic head of the magnetic card processing part 8 and the camera of the code reading part 9. A data signal including secret information is inputted into the main control part 11. The control board 12 is formed with a signal circuit for transmitting a data signal including secret information.

The protection board 14 is structured of two flexible printed boards 23 and 24 which are bent in predetermined shapes. In other words, the protection board 14 is a flexible printed board. In this embodiment, the control board 12 is surrounded by the two flexible printed boards 23 and 24. In other words, the control board 12 is surrounded by the protection board 14. The detection circuit 13 is formed in an entire area of each of the flexible printed boards 23 and 24. The detection circuit 13 is, for example, structured of two pattern wirings.

The detection circuit 13 is electrically connected with the main control part 11. Specifically, the detection circuit 13 is electrically connected with the microcomputer 20. The main control part 11 (specifically, microcomputer 20) detects disconnection of the detection circuit 13 when at least one of the two pattern wirings structuring the detection circuit 13 is disconnected. Further, the main control part 11 detects a short circuit of the detection circuit 13 when one and the other of the two pattern wirings structuring the detection circuit 13 are short-circuited.

A region which is surrounded by the two flexible printed boards 23 and 24 is formed as a protection region where the control board 12 is disposed. The protection region is a region surrounded by the detection circuit 13 and is a region where safety (security) is secured. In the embodiment shown in FIG. 3, although the entire control board 12 is surrounded by the protection board 14, it may be structured that a part of the control board 12 is not surrounded by the protection board 14. In other words, the protection board 14 may surround a part of the control board 12.

As described above, the control board 12 and the protection board 14 are accommodated in the housing 15. Further, the housing 15 accommodates the communication antenna, the IC contact springs of the IC card processing part 7, the magnetic head of the magnetic card processing part 8, the cameras of the code reading part 9 and the like. The frame member 6 is fixed to a front end part of the housing 15. The display 5 is disposed on an inner peripheral side of the frame member 6.

The disassembly detection mechanism 16 is, for example, a mechanical sensor having a contact switch. The disassembly detection mechanism 16 is, for example, disposed between the frame member 6 and the housing 15. The disassembly detection mechanism 16 is electrically connected with the main control part 11. Specifically, the disassembly detection mechanism 16 is electrically connected with the microcomputer 20. The main control part 11 (specifically, microcomputer 20) detects that the information processing device 2 is disassembled when the frame member 6 is detached from the housing 15.

The display 5 is a liquid crystal display. Therefore, in the following descriptions, the display 5 is referred to as a “liquid crystal display 5”. The liquid crystal display 5 is, as described above, a display with a touch panel and is provided with an input function of information in addition to a display function of information. The liquid crystal display 5 includes a liquid crystal panel, a touch panel 27, and a control board 29 on which a control part 28 controlling the liquid crystal display 5 is mounted. The control board 29 is electrically connected with the control board 12 through a flexible printed board 30 (hereinafter, referred to as an “FPC 30”).

The touch panel 27 includes a touch position detection mechanism 31 for detecting a touch position (coordinate) which is a position where the touch panel 27 is touched. Further, the liquid crystal display 5 includes a flexible printed board 32 (hereinafter, referred to as an “FPC 32”) which electrically connects the touch panel 27 with the control board 29, a battery 33 which supplies power to the liquid crystal display 5 in a state that power is not supplied from the outside, and a disassembly detection mechanism 34 for detecting that the liquid crystal display 5 is disassembled.

The control board 29 is, for example, a rigid board such as a glass epoxy substrate. The control part 28 includes a microcomputer 37. The microcomputer 37 includes a CPU 38 similarly to the microcomputer 20. Further, the microcomputer 37 includes a ROM, a RAM, peripheral circuits and the like similarly to the microcomputer 20. The control part 28 is electrically connected with the main control part 11 through the FPC 30.

The touch position detection mechanism 31 is incorporated into the touch panel 27. The touch panel 27 is, for example, a capacitance-type touch panel, and the touch position detection mechanism 31 is a capacitance sensor. The touch position detection mechanism 31 is electrically connected with the control part 28 through the FPC 32. Specifically, the touch position detection mechanism 31 is electrically connected with the microcomputer 37. The control part 28 encrypts data of touch positions detected by the touch position detection mechanism 31 and transmits them to the main control part 11. Specifically, the microcomputer 37 encrypts data of touch positions and transmits them to the main control part 11. In accordance with an embodiment of the present invention, the touch panel 27 may be a touch panel of another type such as a resistance film type.

As described above, the battery 33 supplies power to the liquid crystal display 5 in a state that power is not supplied from the outside. Specifically, when power is not supplied to the liquid crystal display 5 from the outside, the battery 33 supplies power to the CPU 38 for operating a part of the CPU 38. The disassembly detection mechanism 34 is, for example, a mechanical sensor having a contact switch. The disassembly detection mechanism 34 is electrically connected with the control part 28. Specifically, the disassembly detection mechanism 34 is electrically connected with the microcomputer 37. The control part 28 (specifically, microcomputer 37) detects that the liquid crystal display 5 is disassembled based on a detection result of the disassembly detection mechanism 34.

The FPC 32 is formed with a detection circuit 40 for detecting its own disconnection and its short circuit, and a signal circuit for transmitting an output signal of the touch position detection mechanism 31. The FPC 32 includes a detection circuit layer 41 where the detection circuit 40 is formed, and a signal circuit layer 42 where a signal circuit is formed (see FIG. 5). The detection circuit layer 41 and the signal circuit layer 42 are overlapped with each other in a thickness direction of the FPC 32. The detection circuit 40 is formed in the entire area of the FPC 32. The detection circuit 40 is, for example, structured of two pattern wirings.

The detection circuit 40 is electrically connected with the control part 28. Specifically, the detection circuit 40 is electrically connected with the microcomputer 37. The control part 28 (specifically, microcomputer 37) detects that the detection circuit 40 is disconnected when at least one of the two pattern wirings structuring the detection circuit 40 is disconnected. Further, the control part 28 detects a short circuit of the detection circuit 40 when one and the other of the two pattern wirings structuring the detection circuit 40 are short-circuited.

In the information processing device 2, when communication of data is to be performed with a card 3 or a smartphone 4 in a non-contact manner, a user holds the card 3 or the smartphone 4 over the liquid crystal display 5 from a front side. Further, when data of communication is to be performed with a contact type IC card in the IC card processing part 7, a user performs an insertion and taking-out operation of the card 3 in the front and rear direction to the IC card processing part 7. When reading and the like of magnetic data is performed in the magnetic card processing part 8, a user operates a card 3 toward a lower side with respect to the magnetic card processing part 8.

When reading of a two-dimensional code or the like is to be performed in the code reading part 9, for example, a user holds a two-dimensional code displayed on the smartphone 4 over the code reading part 9. Further, a personal ID number is inputted with the liquid crystal display 5. When the personal ID number is to be inputted, for example, keys of numerals “0” through “9” are displayed on the liquid crystal display 5. A user touches the liquid crystal display 5 to input his/her personal identification number or the like.

In this embodiment, the control part 28 executes a predetermined tamper-resistant processing (abnormality processing) when at least one of disconnection and a short circuit of the detection circuit 40 is detected. Further, the control part 28 executes tamper-resistant processing when the control part 28 detects that the liquid crystal display 5 is disassembled. Specifically, the control part 28 stops at least an operation of the CPU 38 and sets the CPU 38 in an unusable state as the tamper-resistant processing.

In a case that the CPU 38 is set in an unusable state, even when an “ON”, “OFF” or reset of a power supply of the information processing device 2 is performed, the CPU 38 is not restored. In this embodiment, when the control part 28 detects at least one of disconnection and a short circuit of the detection circuit 40, the detection content is stored in the RAM of the microcomputer 37. Further, also in a case that the control part 28 detects that the liquid crystal display 5 is disassembled, the detection content is stored in the RAM of the microcomputer 37.

Further, the main control part 11 monitors the control part 28 and, when the control part 28 executes the tamper-resistant processing, the main control part 11 notifies the host control part 22 of that the tamper-resistant processing has been executed. Further, in this embodiment, when the main control part 11 detects at least one of disconnection and a short circuit of the detection circuit 13, the main control part 11 makes the control part 28 execute the tamper-resistant processing. Further, when the main control part 11 detects that the information processing device 2 is disassembled, the main control part 11 makes the control part 28 execute the tamper-resistant processing.

### Principal Effects in this Embodiment

As described above, in this embodiment, the control part 28 executes tamper-resistant processing when the control part 28 detects at least one of disconnection and a short circuit of the detection circuit 40 and when the control part 28 detects that the liquid crystal display 5 is disassembled. In other words, in this embodiment, when the control part 28 detects an illegal act to the liquid crystal display 5 with a touch panel, tamper-resistant processing is executed. Therefore, according to this embodiment, safety of the liquid crystal display 5 with a touch panel itself can be enhanced. Further, in this embodiment, safety of the liquid crystal display 5 itself can be enhanced and thus, a design of the information processing device 2 which requires safety is easily performed.

In this embodiment, when the main control part 11 detects at least one of disconnection and a short circuit of the detection circuit 13, the main control part 11 makes the control part 28 execute tamper-resistant processing and, when the main control part 11 detects that the information processing device 2 is disassembled, the main control part 11 makes the control part 28 execute the tamper-resistant processing. In other words, in this embodiment, also in a case that an illegal act is detected in a portion of the information processing device 2 other than the liquid crystal display 5, the control part 28 executes the tamper-resistant processing. Therefore, according to this embodiment, safety of the liquid crystal display 5 with a touch panel itself can be further enhanced.

In this embodiment, the main control part 11 monitors the control part 28 and, when the control part 28 executes tamper-resistant processing, the main control part 11 notifies the host control part 22 of that the tamper-resistant processing has been executed. Therefore, in this embodiment, the host control part 22 is capable of recognizing that the tamper-resistant processing has been executed in the liquid crystal display 5.

### Other Embodiments

Although the present invention has been shown and described with reference to a specific embodiment, various changes and modifications will be apparent to those skilled in the art from the teachings herein.

In the embodiment described above, the control part 28 may detect only disconnection of the detection circuit 40 or may detect only a short circuit of the detection circuit 40. Similarly, the main control part 11 may detect only disconnection of the detection circuit 13 or may detect only a short circuit of the detection circuit 13. Further, in the embodiment described above, each of the detection circuits 13 and 40 may be structured of one pattern wiring. In this case, the main control part 11 detects disconnection of the detection circuit 13 when the one pattern wiring is disconnected, and the control part 28 detects disconnection of the detection circuit 40 when the one pattern wiring is disconnected. In addition, in the embodiment described above, each of the detection circuits 13 and 40 may be structured of three or more pattern wirings.

In the embodiment described above, the FPC 32 is formed with no detection circuit 40. In other words, the liquid crystal display 5 may be provided with no FPC 32 in which the detection circuit 40 is formed. Further, in the embodiment described above, the liquid crystal display 5 may be provided with no disassembly detection mechanism 34. Further, in the embodiment described above, the protection board 14 may be structured of one flexible printed board or may be structured of a plurality of rigid boards. In addition, in the embodiment described above, the information processing device 2 may be provided with no protection board 14 and may be provided with no disassembly detection mechanism 16.

In the embodiment described above, it may be structured that the main control part 11 does not monitor the control part 28. Further, in the embodiment described above, it may be structured that the main control part 11 does not make the control part 28 execute the tamper-resistant processing when the main control part 11 detects at least one of disconnection and a short circuit of the detection circuit 13, or the main control part 11 does not make the control part 28 execute the tamper-resistant processing when disassembling of the information processing device 2 is detected.

In the embodiment described above, the display 5 may be a display such as an organic EL display other than a liquid crystal display. Further, in the embodiment described above, the information processing device 2 is not required to provide with at least one of the IC card processing part 7, the magnetic card processing part 8 and the code reading part 9. In addition, in the embodiment described above, non-contact communication of information may be performed between an information recording medium other than a card 3 and the information processing device 2, and non-contact communication of information may be performed between an electronic device such as an RFID tag other than a smartphone 4 and the information processing device 2.

### Structures of Embodiments

Embodiments of the present invention may be structured as follows.
(1) An information processing device including a display with a touch panel to which secret information is inputted, where
the display includes a touch position detection mechanism for detecting a touch position which is a touched position of the touch panel, a battery which supplies power to the display in a state that power is not supplied from the outside, and at least one of a flexible printed board which is formed with a detection circuit for detecting at least one of its own disconnection and short circuit and a signal circuit for transmitting an output signal of the touch position detection mechanism, and a disassembly detection mechanism for detecting that the display is disassembled,
in a case that the display includes the flexible printed board, a control part which controls the display executes a predetermined tamper-resistant processing when the control part detects at least one of disconnection and a short circuit of the detection circuit, and
in a case that the display includes the disassembly detection mechanism, the control part executes the tamper-resistant processing when the control part detects that the display is disassembled.
(2) The information processing device described in the above-mentioned structure (1), where the display includes the flexible printed board and the disassembly detection mechanism.
(3) The information processing device described in the above-mentioned structure (1) or (2), where the control part includes a CPU, and the tamper-resistant processing stops at least an operation of the CPU to set the CPU in an unusable state.
(4) The information processing device described in one of the above-mentioned structures (1) through (3), where a main control part which controls the information processing device monitors the control part and, when the control part executes the tamper-resistant processing, the main control part notifies a host control part electrically connected with the main control part of that the tamper-resistant processing has been executed.
(5) The information processing device described in one of the above-mentioned structures (1) through (4), where the information processing device includes a control board on which a main control part controlling the information processing device is mounted, a protection board which is a printed board formed with a second detection circuit for detecting at least one of its own disconnection and short circuit and surrounding at least a part of the control board, and a second disassembly detection mechanism for detecting that the information processing device is dis assembled,
the main control part makes the control part execute the tamper-resistant processing when the main control part detects at least one of disconnection and a short circuit of the second detection circuit, and
when the main control part detects that the information processing device is disassembled, the main control part makes the control part execute the tamper-resistant processing.

In this embodiment, it is preferable that the display includes the flexible printed board and the disassembly detection mechanism. According to this structure, when at least one of disconnection and a short circuit of the detection circuit is detected, the tamper-resistant processing is executed and, also when it is detected that the display is disassembled, the tamper-resistant processing is executed. Therefore, the safety of the display with a touch panel itself can be further enhanced.

In this embodiment, for example, the control part includes a CPU and, as the tamper-resistant processing, at least an operation of the CPU is stopped and the CPU is set in an unusable state.

In this embodiment, it is preferable that the main control part which controls the information processing device monitors the control part and, when the control part executes tamper-resistant processing, the main control part notifies a host control part connected electrically of that the tamper-resistant processing has been executed. According to this structure, the host control part is capable of recognizing that the tamper-resistant processing has been executed in the display.

In this embodiment, it is preferable that the information processing device includes a control board on which a main control part controlling the information processing device is mounted, a protection board which is a printed board formed with a second detection circuit for detecting at least one of its own disconnection and short circuit and surrounding at least a part of the control board, and a second disassembly detection mechanism for detecting that the information processing device is disassembled. The main control part makes the control part execute the tamper-resistant processing when the main control part detects at least one of disconnection and a short circuit of the second detection circuit and, when the main control part detects that the information processing device is disassembled, the main control part makes the control part execute the tamper-resistant processing. In other words, it is preferable that the control part executes the tamper-resistant processing even when an illegal act is detected in a portion of the information processing device other than the display. According to this structure, safety of the display with a touch panel itself can be further enhanced.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An information processing device comprising a display with a touch panel to which secret information is inputted, wherein the display comprises:
a touch position detection mechanism which detects a touch position that is a touched position of the touch panel;
a battery which supplies power to the display in a state that power is not supplied from an outside; and
at least one of:
a flexible printed board which is formed with a detection circuit for detecting at least one of its own disconnection and short circuit, and a signal circuit for transmitting an output signal of the touch position detection mechanism; and
a disassembly detection mechanism for detecting that the display is disassembled;
in a case that the display comprises the flexible printed board, a control part which controls the display executes a predetermined tamper-resistant processing when the control part detects at least one of disconnection and a short circuit of the detection circuit; and
in a case that the display comprises the disassembly detection mechanism, the control part executes the tamper-resistant processing when the control part detects that the display is disassembled.

2. The information processing device according to claim 1, wherein the display comprises the flexible printed board and the disassembly detection mechanism.

3. The information processing device according to claim 1, wherein
the control part comprises a CPU, and
the tamper-resistant processing stops at least an operation of the CPU to set the CPU in an unusable state.

4. The information processing device according to claim 1, wherein
a main control part which controls the information processing device monitors the control part, and
when the control part executes the tamper-resistant processing, the main control part notifies a host control part electrically connected with the main control part of that the tamper-resistant processing has been executed.

5. The information processing device according to claim 1, further comprising:
a control board on which a main control part controlling the information processing device is mounted;
a protection board which is a printed board formed with a second detection circuit for detecting at least one of its own disconnection and short circuit and surrounding at least a part of the control board; and
a second disassembly detection mechanism for detecting that the information processing device is disassembled,
wherein the main control part makes the control part execute the tamper-resistant processing when the main control part detects at least one of disconnection and a short circuit of the second detection circuit, and
when the main control part detects that the information processing device is disassembled, the main control part makes the control part execute the tamper-resistant processing.

6. The information processing device according to claim 2, wherein
the control part comprises a CPU, and
the tamper-resistant processing stops at least an operation of the CPU to set the CPU in an unusable state.

7. The information processing device according to claim 2, wherein
a main control part which controls the information processing device monitors the control part, and
when the control part executes the tamper-resistant processing, the main control part notifies a host control part electrically connected with the main control part of that the tamper-resistant processing has been executed.

8. The information processing device according to claim 2, further comprising:
a control board on which a main control part controlling the information processing device is mounted;
a protection board which is a printed board formed with a second detection circuit for detecting at least one of its own disconnection and short circuit and surrounding at least a part of the control board; and
a second disassembly detection mechanism for detecting that the information processing device is disassembled,
wherein the main control part makes the control part execute the tamper-resistant processing when the main control part detects at least one of disconnection and a short circuit of the second detection circuit, and
when the main control part detects that the information processing device is disassembled, the main control part makes the control part execute the tamper-resistant processing.
